(19) United States
(12) Patent Application Publication
(10) Pub. No.: US 2011/0306488 A1
(43) Pub. Date: Dec. 15, 2011

(54) OXYGEN ADSORBER WITH GLYCERIN AND CHABAZITE

(75) Inventors: Thomas H. Powers, Mayville, NY (US); David S. Payne, West Seneca, NY (US); John W. Crump, Buffalo, NY (US); George E. McKedy, Williamsville, NY (US)

(73) Assignee: MULTISORB TECHNOLOGIES, INC, Buffalo, NY (US)

(21) Appl. No.: 12/813,433

(22) Filed: Jun. 10, 2010

(51) Int. Cl. B01J 20/18; B01J 20/20; B01J 20/22

(52) U.S. Cl. 502/62; 502/74

(57) ABSTRACT

An oxygen absorber includes iron, chabazite, water and glycerin. The oxygen absorber provides quicker oxygen uptake without excessive heating.

### BACKGROUND OF THE INVENTION

1. Field of the Invention

This invention relates generally to oxygen adsorbers and, more particularly, to oxygen adsorbers including iron and one or both of glycerin and chabazite useful for many applications including but not limited to absorbing oxygen from blood or blood products.

2. Description of Related Art

none

### BRIEF SUMMARY OF THE INVENTION

Applicants have discovered that adding chabazite to iron-based oxygen adsorbers promotes absorption. The chabazite has a much higher chloride content than other water carriers. The chloride ions will readily dissolve in water to form a strong electrolyte. Once the ions are dissolved in water, there are ions flowing to produce an electric current. It is this current that allows the flow of electrons for the oxidation/reduction of iron. The chloride ions give the pathway for the transfer of electrons and the oxidation/reduction reaction. Chlorine, as indicated by the magnitude of its standard reduction potential of 1.36 is a strong oxidizing agent. The electrolyte accelerates corrosion and hence oxygen absorption by increasing the rate of the flow of electrons from iron to oxygen.

A chemical reaction occurs at the cathode where electrons are consumed and another reaction occurs at the anode where electrons are produced to be taken up by the anode. As a result, a negative cloud develops around the anode. The irons in the electrode move to neutralize these charges so that the reactions can continue and the electrons keep flowing. The oxygen mount fuels are reduced at the cathode and iron is reduced at the anode. Electrons are transferred between molecules, and electrolytes accelerate corrosion by increasing the flow of electrons from iron to oxygen. Chloride is a strong electrolyte which is a substance containing free ions that make the substance electrically conductive.

### DETAILED DESCRIPTION OF THE INVENTION

In accordance with the invention, the following ingredients were used:
a) Sorbox 101: 267.2+/−0.7 pounds;
b) Sorbox 103: 267.2+/−0.7 pounds;
c) Chabazite: 267+/−0.7 pounds;
d) 02-02749AH01 Carbon: 133.6+/−0.3 pounds;
e) 02-00503AH07 Carbon: 133.6+/−0.3 pounds; and
f) Glycerin: 10.8+/−6.1 pounds.

The ingredients are combined as follows:
a) Combine the iron, chabazite, and carbon in the mixer which can be, for example, a Forberg 18 cubic foot, 1,080 pound mixer with an integral chopper; add the glycerin solution to the liquid feed tank and mix while adding liquid for eight minutes.
b) Then mix and chop for two minutes.

The resulting mixture is unloaded into four drums with double liners. The liners are secured with a twist-tie, the drums are closed, and the product is complete. The process is described in more detail on Attachment A:

The ingredients are described in more detail on the following attachments:
a) Attachment B—Activated carbon;
b) Attachment C—Chabazite;
c) Attachment D—Sorbox 101 iron;
d) Attachment E—Sorbox 103 iron.

### Example Two

In accordance with another example of this invention described in Attachment F, the following ingredients are combined as described below:
a) Sorbox 101 248.4+/−0.6 pounds;
b) Sorbox 103 248.4+/−0.6 pounds;
c) Chabazite 248.4+/−0.6 pounds;
d) 02/00503AH07 Carbon 124.2+/−0.3 pounds;
e) 02-02749AH01 Carbon 124.2+/−0.3 pounds;
f) Klucel EF12 mix 84.6+/−0.2 pounds;

The process proceeds as follows:
a) Add the iron, chabazite described in Attachment I, and carbon to a Forberg mixer mix for two minutes.
b) Add the Klucel EF12 solution prepared as described in Attachment H to the mixer liquid feed tank and simultaneously mix and add the liquid for twelve minutes.
c) Then scrape down the sides of the mixer and simultaneously mix and chop for two minutes. The finished mix should be unloaded into four drums with double liners. Secure the liners with twist-ties, close the drums and label the drums.

The mixed product is allowed rest for 24-hours before being used.

Attachment G describes the preparation of the water and salt solution used in each of the examples in more detail. Attachment H describes the preparation of the Klucel solution in additional detail.

Applicant believes that carbon has a catalytic effect.

In accordance with another aspect of this invention, the oxygen adsorber is provided in sachets. The sachets are prepared generally as follows: the dry mixture is prepared, water and the electrolyte are mixed together, and the dry mixture and water/electrolyte mixtures are dispensed into a sachet and the sachet is sealed. The sachet is preferably placed in an oxygen impermeable container for storage prior to use.

Attachment I is a report showing of the amount of chloride extracted from samples of various materials. In order to determine whether it is the chloride in the chabazite that increases the oxygen uptake of the scavenger, Applicant compared a chabazite based scavenger with a scavenger based on salt having a substantially equal amount of chloride and the chabazite sample performed significantly better. Applicant believes that chabazite is acting as a catalyst for the iron reduction reaction.

The catalytic effect of the carbon is dependent on the structure of the activated carbon and the surface area. A gram of activated carbon has the internal surface area of about 1,200 square meters per frame. The greater the internal surface area the greater the catalytic affect. Activated carbons with high internal surface area offer many sites for surface catalyzed reactions. The functional groups on the pore surface play an important role in the surface catalyzed reactions.

Attached as Attachment C is a technical data sheet on the chabazite that lists the oxides that are in the sodium chabazite that we are using.

The current salt solution contains carbonate, sodium chloride, sodium thiosulfate and water prepared as described in Attachment G.

Applicant believes that combination of iron with either chabazite or activated carbon or both provides enhanced results both based on the conductivity of the chabazite and carbon being higher than other water carriers. Chabazite contains many oxides such as potassium, sodium, calcium, and iron that are believed to produce many free ions in chabazite that are released in solution and give high conductivity. The following table compares the conductivity of chabazite with a number of other materials.

| | Conductivity | |
|---|---|---|
| | (μs/cm | pH |
| Chabazite | 1491. | 9.231 |
| Distilled water | 6.98 | 6.677 |
| 4A Molecular sieve | 125.7 | 8.882 |
| Silica gel type B | 72.6 | 6.744 |
| Clay, Oklahoma wet | 19.2 | 7.984 |
| Activated carbon | | |
| 02-00503AH07 Calgon | 1235. | 10.217 |
| 02-02749AH01 Jacobi | 1546. | 10.037 |

Applicant has found that oxygen adsorbers made in accordance with this invention have the following benefits:
a) Binder with lower water content, reducing the chance of preactivation and overall lower water activity for the product;
b) Introduction of chabazite, a natural zeolite which also acts as a catalyst to the oxygen absorption reaction through the presence of chloride ions at a concentration of 2;
c) The addition of a poly alcohol conditions and facilitates the electrolytic reactions; and
d) The polyol also provides functionality at low temperatures, acting as an antifreeze, reducing the overall heat produced by the product as it begins to absorb.

Oxygen adsorbers made in accordance with this invention provide increased rates of absorption for many food applications along with shorter lifetimes before the absorption commences. A disadvantage of known oxygen adsorbers is their high cost and increase in production of hydrogen due to lack of oxygen for absorption and high pH during the exothermic oxygen forming reaction.

Applicant believes that the present invention provides improved oxygen adsorption with enhanced electrolyte reactions but shorter lag times before adsorption begins. but does not become as hot as previously known adsorbers when exposed to oxygen for an appreciable time.

While chabazite is presently preferred, other zeolites may be used including zeolites that are loaded with materials such as chlorides or chlorine.

While the invention has been described in connection with certain presently known embodiments thereof, those skilled in the art will appreciate that many modifications and changes may be made therein without departing from the true spirit and scope of the invention which accordingly is intended to be defined solely by the appended claims

1. An oxygen adsorber comprising:
iron; and
chabazite.

2. The oxygen adsorber of claim 1 further comprising glycerin.

3. The oxygen adsorber of claim 2 further comprising carbon.

4. The oxygen adsorber of claim 3 further comprising water.

5. The oxygen adsorber of claim 3 in which the iron is selected from the group consisting of sponge iron, electrolytically reduced iron and annealed iron.

6. The oxygen adsorber of claim 1 further comprising carbon.

7. The oxygen adsorber of claim 6 in which the carbon comprises carbon derived from coconut.
